(19) United States
(12) Patent Application Publication
(10) Pub. No.: US 2004/0249693 A1
(43) Pub. Date: Dec. 9, 2004

(54) Schedule management system and schedule management apparatus for mobile users

(76) Inventor: Kazuya Sako, Kobe-shi (JP)

Correspondence Address: CHRISTIE, PARKER & HALE, LLP, PO BOX 7068, PASADENA, CA, 91109-7068, US

(21) Appl. No.: 10/829,121

(22) Filed: Apr. 20, 2004

(30) Foreign Application Priority Data
Jun. 6, 2003 (JP) 2003-162591
Jun. 27, 2003 (JP) 2003-184893

(51) Int. Cl. G06F 17/60

(52) U.S. Cl. 705/8

(57) ABSTRACT

A schedule table is stored in a RAM of a schedule management apparatus and in a schedule storage section of a management center. The schedule management apparatus transmits a present position detected by a GPS to the management center continuously. The management center calculates a required time period to move from the present position of the schedule management apparatus to a place included in the schedule table and, when a time calculated from an expected start time of the schedule is reached, transmits an alarm to the schedule management apparatus. This alarm is displayed on a display section of the schedule management apparatus. By starting to move to the scheduled place, a user can arrive at the place before the expected start time even when the user starts from a place quite far from the scheduled place.

### BACKGROUND OF THE INVENTION

1. Field of the Invention

The present invention relates to a schedule management system for mobile users and a management center and a schedule management apparatus constituting this system.

Further, the present invention relates to an apparatus that manages schedules of mobile users on a standalone basis.

2. Description of the Related Art

It is well-known that PDAs (Personal Digital Assistants), personal computers and the like can function as schedule management apparatuses by storing schedules therein. Such schedule management apparatuses can display the stored schedules on a screen of a display section and give alarms at schedule start times. The alarms are given to the user by sound. The user can know that the time to start an event has arrived with the help of the alarm.

It can be set whether the alarm is given or not for each schedule. If it is set to give the alarm, the schedule management apparatus monitors the expected time to start the event and the present time continuously and sounds an alarm when the expected start time is reached. Further, the alarm can also be output earlier than the expected start time included in the schedule by a predetermined time period. In the following description, this predetermined time period will be referred to as the “time margin”. If the time margin is set, the schedule management apparatus gives the alarm at the time, earlier than the expected start time, according to the time margin. By carrying the schedule management apparatus incorporated into a mobile terminal such as a PDA, a portable PC, a vehicle-mounted device and the like and setting a time period necessary to move to the scheduled place where the event is carried out as the time margin, the user can move to the scheduled place within the time margin after the alarm is given and, as a result, the user can carry out the event at the expected start time. In particular, when the schedule management apparatus is incorporated into the vehicle-mounted device, the user can concentrate on driving the vehicle without concern for the schedule.

However, even though the time margin is set in the schedule management apparatus, if the user stays at a place from which the user cannot reach the scheduled place within the time margin when the alarm is given, there is a problem in that the user cannot arrive at the scheduled place by the expected start time even though the user starts to move after the alarm is given.

When the schedule is registered in the schedule management apparatus or the registered schedule is revised, the user inputs data manually. When the schedule management apparatus is incorporated into the vehicle-mounted device, it is dangerous for the driver to register or revise the schedule by a manual operation while driving the vehicle because it interferes with driving. Further, and also in the case of the schedule management apparatus incorporated into the PDA, it is difficult to operate the schedule management apparatus during movement and, moreover, such an operation is not preferred from the viewpoint of safety because the user is likely to be inattentive to the surroundings during the operation.

### SUMMARY OF THE INVENTION

It is an object of the present invention to provide a schedule management system or a schedule management apparatus that ensures that a user who carries the schedule management apparatus can arrive at an scheduled place before an expected start time.

Further, it is another object of the present invention to provide a schedule management system wherein a cumbersome input operation is not needed when a user who carries a schedule management apparatus registers and revises a schedule in the schedule management apparatus.

The schedule management system of the present invention performs schedule management allowing for a present position of the schedule management apparatus. The schedule management apparatus transmits a schedule to be managed to a management center and, then, transmits its own present position to the management center continuously. The management center stores the schedule received from the schedule management apparatus in memory and, when it receives the present position from the schedule management apparatus, calculates a time period required to move from the present position to a scheduled place included in the schedule. Further, the management center calculates a time to start an alarm based on an expected start time and a time margin included in the schedule, and a present time and, when the alarm time arrives, transmits the alarm to the schedule management apparatus. The schedule management apparatus outputs the alarm received from the management center.

According to the schedule management system of the present invention, the schedule management is performed by allowing for a time period required for the user carrying the schedule management apparatus to reach the scheduled place. Therefore, even when the user has moved to a position quite far from the scheduled place, the alarm is given so that the user can arrive at the scheduled place before the expected start time.

According to the present invention, features of the management center and the schedule management apparatus described above may be incorporated into a standalone schedule management apparatus so that the schedule management apparatus can perform schedule management allowing for the present position on a standalone basis.

The registration and revision of the schedule in the schedule management apparatus of the present invention can be performed under the control of the management center. When the user wishes to register or revise the schedule, the user requests an operator of the management center to register or revise the schedule by using a telephone unit. The operator obtains information necessary for registration or revision of the schedule through conversations with the user and creates or revises a schedule table. The created or revised schedule table is transmitted from the management center to the schedule management apparatus via the telephone unit. The schedule management apparatus stores the received schedule table in a storage section. Thereafter, the management center and the schedule management apparatus perform schedule management according to this schedule table.

According to the present invention, the user can register and revise the schedule without the need to manually manipulate an input operating section. Therefore, even when the schedule management apparatus is incorporated into a vehicle-mounted device, the schedule can be registered and revised easily and, therefore, the user can concentrate on driving and safety can be secured. Further, and also when the schedule management apparatus is incorporated into a PDA, the schedule can be registered or revised easily.

### BRIEF DESCRIPTION OF THE DRAWINGS

The above object and features of the present invention will be more apparent from the following description of the preferred embodiments with reference to the accompanying drawings, wherein:

FIG. 1 shows a configuration of a schedule management system in a first embodiment of the present invention;

FIG. 2 shows a schedule table in a schedule management apparatus of FIG. 1;

FIG. 3 shows a schedule table in a management center of FIG. 1;

FIG. 4 is a flow chart showing an operation of the schedule management apparatus of FIG. 1;

FIG. 5 is a flow chart showing an operation of the management center of FIG. 1;

FIG. 6 shows a configuration of a schedule management apparatus in a second embodiment of the present invention;

FIG. 7 is a flow chart showing an operation of the schedule management apparatus of FIG. 6;

FIG. 8 shows a configuration of a schedule management system in a third embodiment of the present invention; and

FIG. 9 is a time chart showing an operation of the system of FIG. 8.

### DESCRIPTION OF THE PREFERRED EMBODIMENTS

Hereinafter, examples in which a schedule management apparatus, to which the present invention is applied, is incorporated into a vehicle-mounted device will be described with reference to the drawings.

(Embodiment 1)

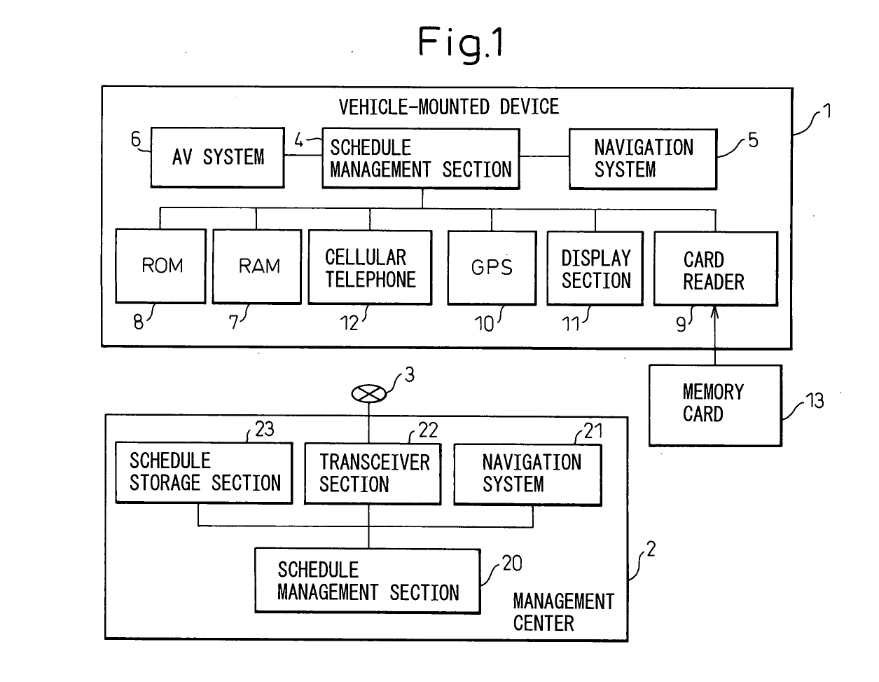

FIG. 1 shows a general configuration of a schedule management system in a first embodiment of the present invention. Functions of a schedule management apparatus are incorporated into a vehicle-mounted device 1. The vehicle-mounted device 1 can communicate with a management center 2 via a cellular telephone line 3.

The vehicle-mounted device 1 is equipped with a schedule management section 4, a navigation system 5 and an AV system 6. The schedule management section 4, the navigation system 5 and the AV system 6 may be constituted by a single CPU collectively or each of these elements may be constituted by respective CPUs separately. The schedule management section 4 is connected to the navigation system 5, a RAM 7, a ROM 8, a card reader 9, a GPS (Global Positioning System) 10, a display section 11 and a cellular telephone 12. The display section 11 includes a liquid crystal display, a speaker and so on and also acts as a display section of the navigation system 5 and the AV system 6. The schedule management section 4 exchanges data with the management center 2 via the cellular telephone 12 and the cellular telephone line 3.

The management center 2 comprises a schedule management section 20, a navigation system 21, a transceiver section 22 for communicating with the vehicle-mounted device 1, and a schedule storage section 23.

A schedule can be registered and revised in the vehicle-mounted device 1 in an arbitrary manner. As a first method, the schedule can be registered and revised by manual operation directly. In this case, an input operation section (not shown) of the navigation system 5 and the AV system 6 is utilized to input entries. As a second method, the schedule managed by a separate personal computer or a PDA can be copied to a memory card 13 such as an SD memory and the memory card can be inserted into the card reader 9. The loaded schedule is stored in the RAM 7. As a third method, the schedule registered in the personal computer or the PDA can be transferred to the vehicle-mounted device 1 via a wireless LAN. As a fourth method, as described later, the schedule can be registered and revised by exchanging data with the management center 2. This fourth method will be described in detail later.

The schedule management section 4 performs schedule management functions to register and revise the schedule, to display the schedule on the display section 11, to give an alarm by sound or display on the screen when a schedule start time approaches, and so on. These are well-known functions of the schedule management apparatus and detailed descriptions are omitted here.

The schedule management system of the present invention is characterized in that it performs schedule management allowing for a time period required to move from a present position of the vehicle-mounted device 1 (the schedule management apparatus) to a place included in a schedule.

An operation of the schedule management system shown in FIG. 1 will be described.

First, an outline of the operation will be provided. A schedule is input to the vehicle-mounted device 1 and stored in the RAM 7 as a schedule table 14.

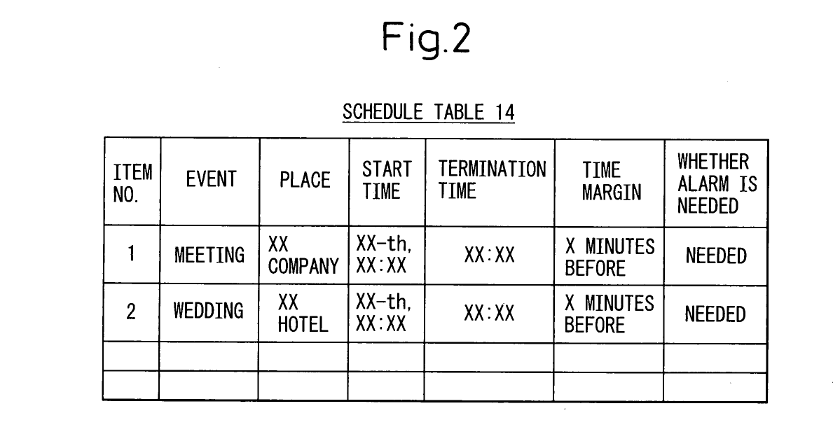

FIG. 2 shows the schedule table 14. For each schedule, an item number, an event such as a meeting, a wedding and the like, a place such as names of a company, a wedding ceremony hall and the like, a start time of the schedule, a termination time, a time margin to give an alarm before the start time, and an indication of whether or not the alarm is needed are recorded. In the field indicating whether or not the alarm is needed, “needed” is set if the alarm is needed or “not needed” is set if the alarm is not needed. In the field of the place, necessary information for obtaining the coordinates (latitude and longitude) of the place, such as the name of the company, the wedding ceremony hall or the like, the telephone number, the postal code and so on is recorded. Here, the latitude and longitude may be recorded in this field directly.

When the schedule table 14 is stored in the RAM 7 of the vehicle-mounted device 1, schedule data is created by attaching a mobile terminal ID, which is stored in the ROM 8, to the schedule table 14 and is transmitted by the cellular telephone 12 to the management center 2 via the cellular telephone line 3. In the management center 2, when the transceiver section 22 receives the schedule data, the schedule management section 20 creates a new management table 15 based on the data and the schedule table is stored in the schedule storage section 23.

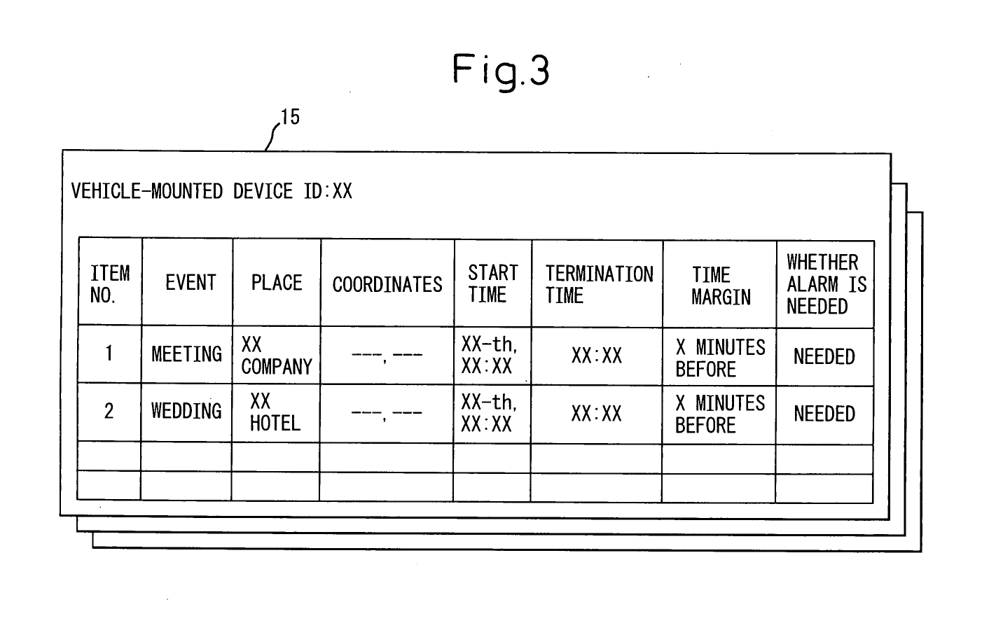

FIG. 3 shows the schedule table 15 stored in the schedule storage section 23. The schedule table 15 is created for each vehicle-mounted device 1 (for each vehicle-mounted device ID). The schedule table 15 has a configuration that is substantially similar to the schedule table 14 in the vehicle-mounted device 1 (FIG. 2) but the coordinates (latitude and longitude) of the place are added. When the coordinates are not stored in the schedule table 14 in the vehicle-mounted device 1, the coordinates are retrieved by using the navigation system 21.

After transmitting the schedule table 14 to the management center 2, the schedule management section 4 in the vehicle-mounted device 1 transmits the present position detected by the GPS 10 with the addition of its vehicle-mounted device ID to the management center 2 continuously. This transmission interval may be any time interval such as, for example, every 5 minutes.

When the schedule management section 20 in the management center 2 receives the present position, it searches the schedule table 15 corresponding to the relevant vehicle-mounted device ID and, for all items marked that “the alarm is needed”, calculates the time required to move from the present position to the scheduled place by using the navigation system 21. Then, the schedule management section 20 determines whether the alarm time is reached based on the present time, the required time, the time margin and the start time. When the alarm time is reached, the schedule management section 20 generates the alarm and transmits it to the relevant vehicle-mounted device 1.

When the schedule management section 4 in the vehicle-mounted device 1 receives the alarm, it displays the alarm by means of the display section 11. Following this alarm, the navigation system 5 may display a map to show the route to the scheduled place. The user goes to the place in response to this alarm. This alarm is given earlier than the expected start time by a time period equal to the sum of the required time and the time margin. Therefore, even when the present position is quite far from the scheduled place, the user can arrive at the place before the expected start time by starting to go to the place in response to the alarm.

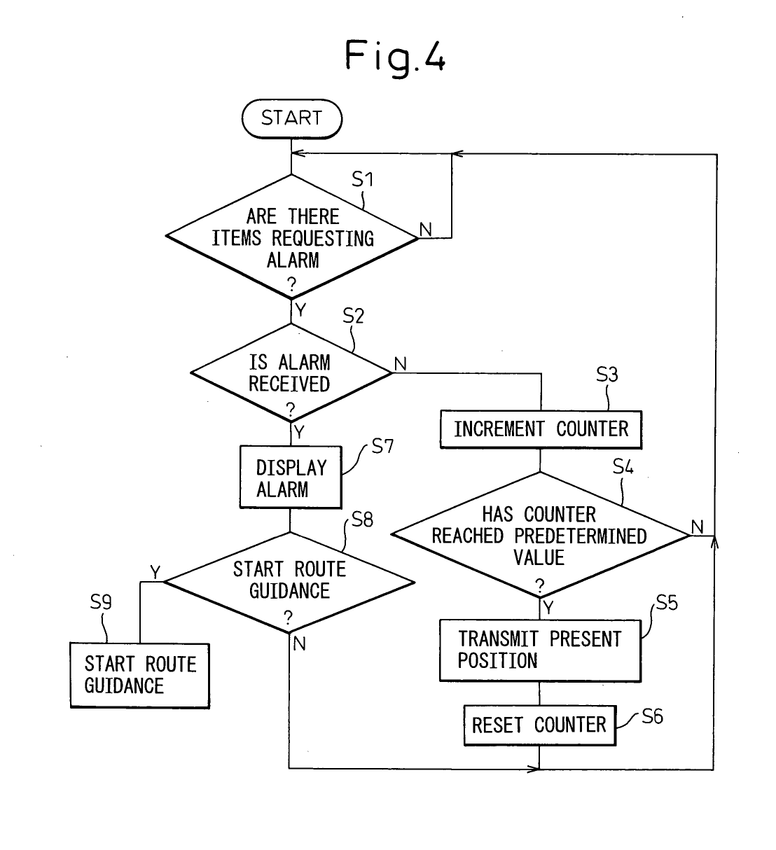

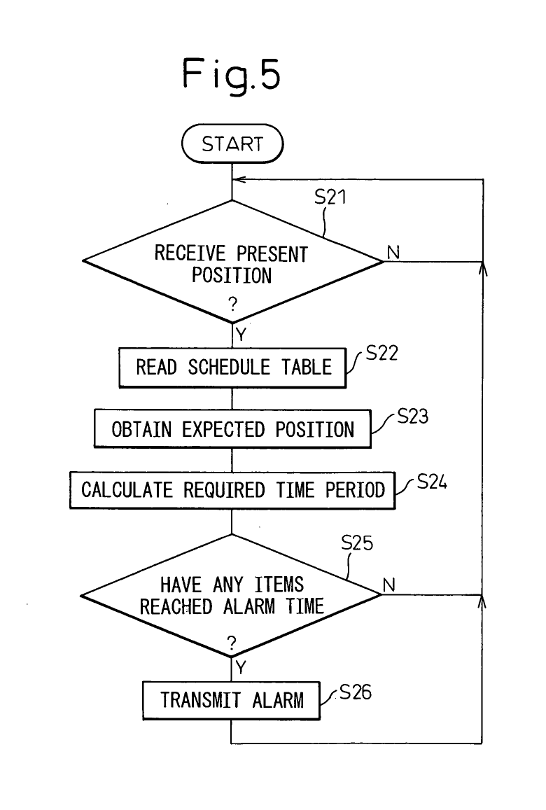

An operation of the schedule management section 4 in the vehicle-mounted device 1 will be described with reference to a flow chart of FIG. 4 and an operation of the schedule management section 20 in the management center 2 will be described with reference to a flow chart of FIG. 5. After the schedule management section 4 in the vehicle-mounted device 1 transmits the schedule to the management center 2, or after the user activates the schedule management apparatus, the schedule management section 4 in the vehicle-mounted device 1 starts the operation shown in FIG. 4. On the other hand, after an operator performs activation, the schedule management section 20 in the management center 2 starts the operation of FIG. 5.

The schedule management section 4 in the vehicle-mounted device 1 determines whether there are any items stored in the schedule table 14 that request the alarm or not (S1). If there is not, step S1 is repeated. If there are items requesting an alarm, it is determined whether the alarm is received from the management center 2 or not (S2). The operation when the alarm is received will be described later. On the other hand, if the alarm is not received, a counter value is incremented (S3) and it is determined whether the counter value has reached a predetermined value or not (S4). This counter value is set so that it reaches the predetermined value when a predetermined time period (for example, 5 minutes) has elapsed. During the period after the count starts till the counter value reaches the predetermined value, the determination in step S4 results in NO and, therefore, the process returns to step S1. As the counter value reaches the predetermined value and the result in step S4 becomes YES, the present position is obtained by the GPS 10 and, with the addition of the vehicle-mounted device ID extracted from the ROM 8, transmitted to the management center 2 by the cellular telephone 12 (S5) and, then, the counter is reset (S6). It allows the present position of the vehicle-mounted device 1 to be transmitted to the management center 2 every predetermined time interval. Here, the vehicle-mounted device 1 may be configured to transmit the present position when the vehicle passes through turning points along the route or when the power supply (an ignition key) is turned ON or OFF. In this case, frequency of transmission is reduced and, therefore, the cost of data exchange can be reduced.

The schedule management section 20 in the management center 2 waits until the transceiver section 22 receives the present position from the vehicle-mounted device 1 (S21). When the present position is received from the vehicle-mounted device 1, the schedule management section 20 reads the vehicle-mounted device ID attached to the received data and, then, reads the schedule table 15 corresponding to the vehicle-mounted device ID from the schedule storage section 23 (S22). For all items in the read schedule table 15 that are marked as “needed” in the field indicating whether or not the alarm is needed, the coordinates (latitude and longitude) of the scheduled place are determined (S23). When the coordinates are not stored in the received data, the latitude and longitude are determined from the name, telephone number, postal code and the like of the scheduled place by using the navigation system 21. Then, the required time to move to the scheduled place is determined from the latitude and longitude of the present position of the vehicle-mounted device 1 and the latitude and longitude of the scheduled place by using the navigation system 21 (S24). Then, it is determined whether there are any items that have reached the time to give the alarm or not based on the present time, the required time calculated in step S24, the start date and time indicated in the schedule table 14, and the time margin (S25). For example, if the time when the required time has elapsed after the present time is later than the time when the time margin has elapsed after the start time, it is determined that the alarm time is reached for the item. If it is determined that the alarm time is not reached in this step, the process returns to step S21, where the schedule management section 20 waits for the next reception. On the other hand, if it is determined that the alarm time is reached, the process proceeds to step S26. In step S26, the transceiver section 22 transmits the alarm to the vehicle-mounted device 1. The alarm is created by extracting necessary data for giving the alarm from the schedule table 15. For example, an alarm such as: “XX will start at XX:XX. It will take X hours to go to XX. Start route guidance?” is created by speech synthesis or image synthesis. Further, the entry in the field indicating whether or not the alarm is needed for the relevant items in the schedule table 14 is changed to “alarm given”. Then, the process returns to step S21. The latitude and longitude of the scheduled place is added to the transmitted alarm for the route guidance.

When the schedule management section 4 in the vehicle-mounted device 1 receives the alarm from the management center 2, the process proceeds from step S2 to step S7 of FIG. 4, where the alarm is given on the display section 11 such as the liquid crystal screen, the speaker and the like. Here, it is determined whether or not the user selects to start the route guidance (S8). If the user selects to start the route guidance, the coordinates of the scheduled place included in the received data are transmitted to the navigation system 5 to allow the navigation system 5 to start the route guidance (S9). As a consequence, a map indicating the route is displayed on the screen of the display section 11. On the other hand, if the user selects that the route guidance is not necessary, the process returns to step S1.

If the user moves the vehicle to the scheduled place according to the alarm and the movement can be completed within a normal time period, the user can arrive at the scheduled place earlier than the start time by the time margin. Even when it takes more time than estimated to move the vehicle, if the time margin is defined properly, the user can arrive at the scheduled place before the start time. According to the example described above, even when the user has forgotten the schedule and has driven the vehicle to a place far from the scheduled place, the user can arrive at the place before the start time. Moreover, as most of the schedule management functions are processed in the management center 2, the processing burden on the vehicle-mounted device 1 can be reduced.

Though an example in which the schedule management apparatus is incorporated into the vehicle-mounted device has been described hereinabove, the schedule management apparatus of the present invention can also be incorporated into information processing equipment other than the vehicle-mounted device such as a PDA. Further, when the management center 2 calculates the required time to move to the scheduled place, the moving time can be calculated not only in the case when a personal vehicle is used but also in the case when public transportation, such as a trains or a bus, is used. Therefore, even when the user uses trains, buses and the like, the system of the present invention can be utilized. Further, it is arbitrary whether the time margin is considered when the time to start the alarm is calculated.

(Embodiment 2)

All the schedule management functions in the embodiment 1 above can be incorporated into a standalone vehicle-mounted device. This example will be described as an embodiment 2. In this case, though the processing burden on the vehicle-mounted device is increased in comparison with the embodiment 1, the need to utilize a telephone line is eliminated and, therefore, the communication costs become unnecessary. In the following description, features different from those of the embodiment 1 above will be described mainly and a description of similar features will be omitted.

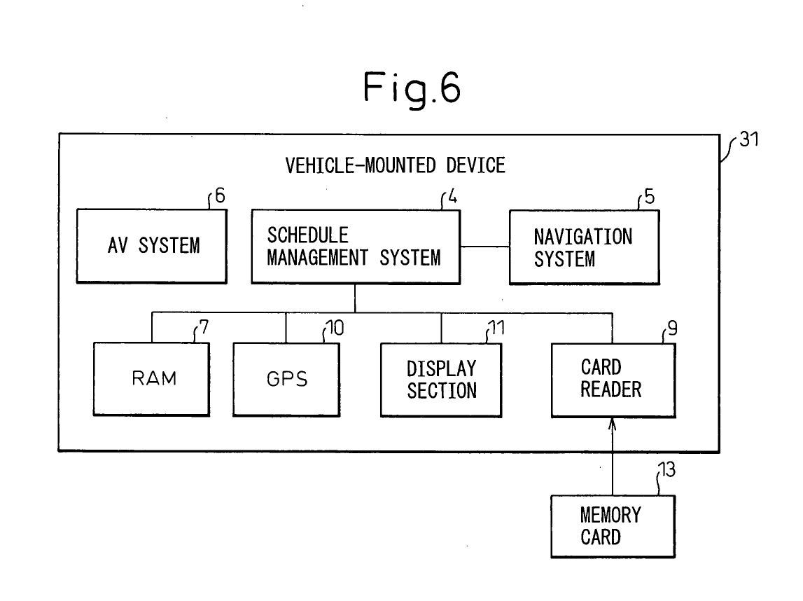

FIG. 6 shows a configuration of a vehicle-mounted device 31. The schedule management section 4 is connected to the RAM 7, the card reader 9, the GPS 10, the navigation system 5 and the display section 11. Though the cellular telephone 12 and the ROM 8 shown in the vehicle-mounted device 1 in FIG. 1 are not shown in FIG. 6, it is to be noted that the vehicle-mounted device 31 can comprise these elements.

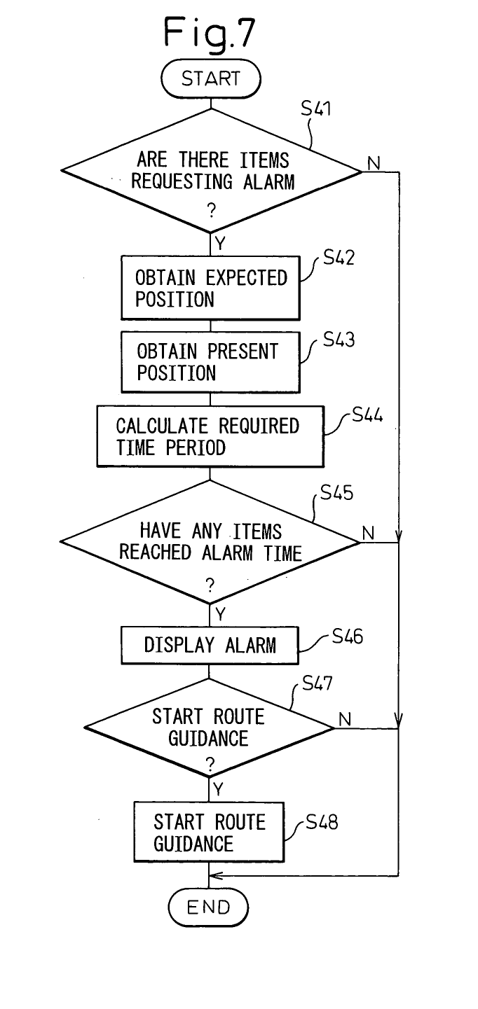

A schedule management method by the schedule management section 4 will be described. The schedule table 14 stored in the RAM 7 is as shown in FIG. 2. After the user activates the schedule functions, the schedule management section 4 starts an operation shown in FIG. 7.

The operation of FIG. 7 is performed every predetermined time interval (for example, every 5 minutes). For all items in the schedule table 14, it is determined whether there are any items that request the alarm or not (S41). If there are such items, the process proceeds to step S42 and, on the other hand, if there is no such item, the process terminates. In step S42, for each item that requests an alarm, the coordinates (latitude and longitude) of the scheduled place are determined. When the latitude and longitude of the scheduled place are not stored in the table 14, the coordinates are determined by using the navigation system 5. Then, the present position (latitude and longitude) of the vehicle-mounted device 31 is detected by using the GPS 10 (S43). Then, the required time to move from the present position to each scheduled place is calculated by using the navigation system 5 (S44). Then, it is determined whether there are any items that have reached the time to give the alarm or not based on the present time, the required time calculated in step S44, the start time indicated in the schedule table 14, and the time margin for each item (S45). Here, if it is determined that no item reaches the time to give the alarm, the process terminates and, on the other hand, if it is determined that the time to give the alarm has been reached, the process proceeds to step S46. In step S46, the alarm is created by extracting data for giving the alarm from the schedule table 14 and the alarm is displayed on the display section 11. Further, the entry in the field indicating whether or not the alarm is needed for the relevant items in the schedule table 14 is changed to “alarm given”. Then, in step S47, it is determined whether or not the user selects to start the route guidance. If the user selects to start the route guidance, the route guidance to the scheduled place is provided by the navigation system 5. On the other hand, if the user does not select to start the route guidance, the process terminates.

(Embodiment 3)

An example in which the schedule is registered and revised under the control of a management center will be described as embodiment 3. In the following description, features different from those of the embodiments 1 and 2 above will be described mainly and the description of similar features will be omitted.

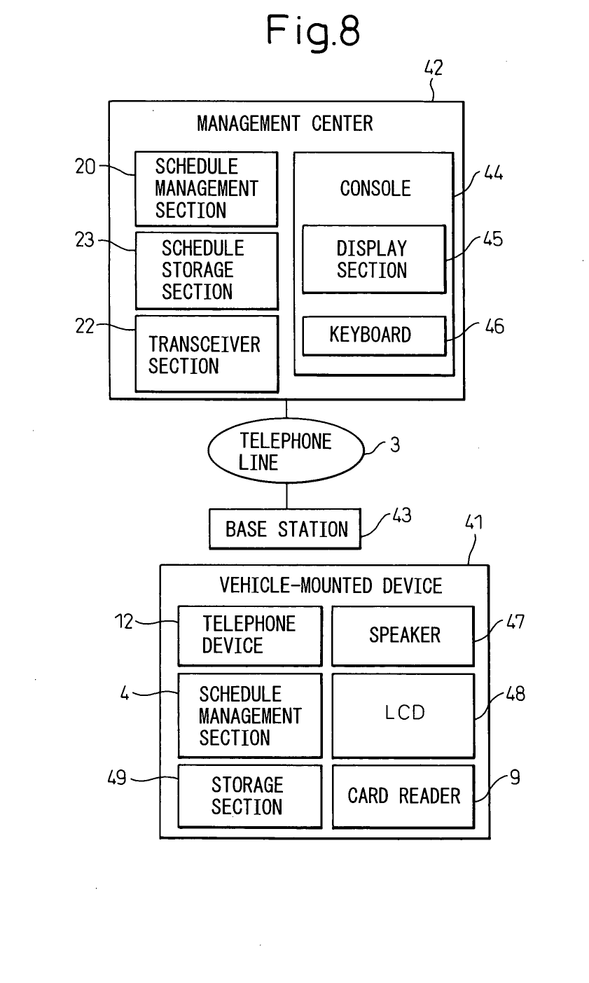

FIG. 8 shows a configuration of a schedule management system. Also in this example, the schedule management system is constituted by a vehicle-mounted device 41 and a management center 42 in a manner similar to that in the system shown in FIG. 1. The vehicle-mounted device 41 can communicate with the management center 42 via a base station 43 and a cellular telephone line 4.

The management center comprises a console 44. The console 44 is equipped with a display section 45 and a keyboard 46. Other elements of the management center 42 are configured similarly to those shown in FIG. 1. As further elements of the management center 42, a schedule management section 20, a transceiver section 22 and a schedule storage section 23 are shown in FIG. 8.

The vehicle-mounted device 1 is also configured in a manner substantially similar to that shown in FIG. 1. However, in FIG. 8, a speaker 47 and a liquid crystal display section 48 that constitute the display section 11 are shown and a storage section 49, in which the RAM 7 and the ROM 8 are included, is shown. As further elements of the vehicle-mounted device 41, a schedule management section 4, a card reader 9 and a telephone device 12 are shown.

The schedule tables used in this example are as shown in FIGS. 2 and 3.

In this example, an operation such as registration and revision of the schedule and so on can be performed in a manner similar to that in the prior art schedule management apparatus. More specifically, the schedule can be registered and revised by manually inputting to the vehicle-mounted device 41, by inserting a memory card 13 in which the schedule is stored into the card reader 9, by transferring the schedule from a PDA and the like via a wireless LAN, and so on. Further, in this example, the operation such as registration and revision of the schedule can be performed in association with the management center 42.

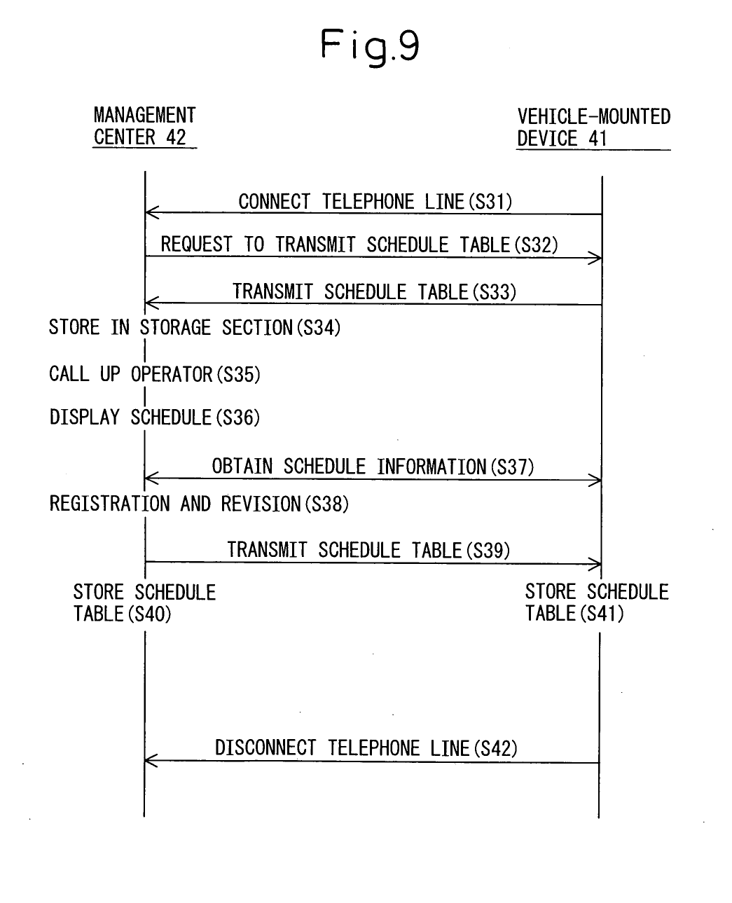

An operation of the schedule management system of FIG. 8 will be described with reference to a time chart of FIG. 9. When the user wishes to request the management center 42 to register or revise the schedule, the user allows a menu screen to be displayed on the liquid crystal display section 48 and selects schedule registration and revision. This action starts the operation of FIG. 3.

The cellular telephone 12 automatically dials a telephone number of the management center 42 to connect the telephone line between the vehicle-mounted device 41 and the management center 42 (S31). A vehicle-mounted device ID is transmitted from the vehicle-mounted device 41 to the management center 42. When the schedule table 15 corresponding to the transmitted vehicle-mounted device ID is not registered in the management center 42, the management center 42 sends a transmission request for the schedule table to the vehicle-mounted device 41 (S32). When the vehicle-mounted device 41 receives this transmission request, it extracts the schedule table 14 from the storage section 49 and transmits it to the management center 42 with the addition of the vehicle-mounted device ID (S33). In the management center 42, the schedule table 15 is created from the received schedule table 14 and stored in the schedule storage section 23 (S34) and, on the other hand, an operator residing at the management center 42 is called up (S35).

The operator displays the schedule table 15 on the display section 45 (S36), talks with the user by telephone (S37) to obtain information for registration or revision of the schedule. Based on the information obtained through the conversation, the operator manipulates the console 44 to register or revise the schedule table 15 (S38). After the registration or revision is finished, the schedule table 14 to be stored in the vehicle-mounted device 41 is created and transmitted to the vehicle-mounted device 41 (S39) and stored in the schedule storage section 23 (S40).

In the vehicle-mounted device 41, the old schedule table 14 that has been stored in the storage section 49 is overwritten with the newly received schedule table 14 (S31). Alternatively, the management center 42 may transmit newly registered or revised parts only and the vehicle-mounted device 41 may overwrite the revised parts only. After the schedule table 14 is stored in the storage section 49, the vehicle-mounted device 41 disconnects the telephone line (S42). It then terminates the shown process.

According to this example, the user can register and revise the schedule by only invoking the menu screen and then having a conversation with the operator by voice. Therefore, even when the user drives the vehicle, the schedule can be registered or revised without impairing safety. Further, when the schedule management apparatus is a PDA and the like, the schedule can similarly be registered or revised, without complicated manipulation, by only having a conversation with the operator. Though the user talks with the operator by using the cellular telephone line 4 in the above example, the conversation can be made also via the Internet by converting the voice into data.

1. A schedule management system, comprising:
a schedule management apparatus that transmits a schedule to be managed to a management center, transmits its own present position to the management center continuously, and displays an alarm when it receives the alarm from said management center; and
the management center that stores the schedule received from said schedule management apparatus, calculates a required time period to move from said present position to a place included in said schedule when it receives said present position from said schedule management apparatus, calculates a time to start an alarm based on an expected start time included in said schedule, a present time and said required time period, and transmits an alarm to said schedule management apparatus through a transmitting/receiving section when the present time reaches said calculated alarm start time.

2. A management center, comprising:
a unit that performs transmission/reception to/from a schedule management apparatus;
a memory that stores a schedule received from said schedule management apparatus through said transmitting/receiving unit;
a unit that detects a present time;
a unit that calculates, from a place included in said schedule and a present position received from said schedule management apparatus, a required time period to move from said present position to said place;
a unit that calculates a time to start an alarm based on an expected start time included in said schedule, said detected present time and said calculated required time period; and
a unit that transmits an alarm to said schedule management apparatus through said transmitting/receiving unit when said detected present time reaches said calculated alarm start time.

3. A schedule management apparatus, comprising:
a unit that performs transmission/reception to/from a management center;
a unit that transmits a schedule to said management center through said transmitting/receiving unit;
a unit that detects a present position;
a unit that transmits said detected present position to said management center through said transmitting/receiving unit; and
a unit that displays an alarm received from said management center through said transmitting/receiving unit.

4. A schedule management apparatus, comprising:
a memory that stores a schedule;
a unit that detects a present position;
a unit that detects a present time;
a unit that calculates, from a place included in said schedule and said detected present position, a required time period to move from said present position to said place;
a unit that calculates a time to start an alarm based on an expected start time included in said schedule, said detected present time and said calculated required time period; and
a unit that displays an alarm when said detected present time reaches said calculated time to start an alarm.

5. A schedule management system, comprising:
a management center that transmits a schedule that is created and input by an operator based on a conversation using a telephone unit between the operator of the management center and a user of said schedule management apparatus; and
the schedule management apparatus that transmits the schedule to said management center through the conversation using the telephone unit, storing the schedule received through said telephone unit in a memory, and displaying the schedule.

6. A management center, comprising:
a unit that telephones with a schedule management apparatus;
a unit that inputs a schedule created from a conversation using said telephone unit;
a memory that stores the schedule input by said inputting unit; and
a unit that transmits said schedule to said schedule management apparatus through said telephoning unit.

7. A schedule management apparatus, comprising:
a unit that telephones with an operator of a management center and receiving data;
a memory that stores a schedule received from the management center through said telephoning unit; and
a unit that displays said received schedule.
